(19) United States
(12) Patent Application Publication
(10) Pub. No.: US 2011/0099744 A1
(43) Pub. Date: May 5, 2011

(54) SCRAPER

(76) Inventors: Helmut Sterkl, Kottlach (AT); Hubert Bischof, Murzzuschlag (AT)

(21) Appl. No.: 12/938,473

(22) Filed: Nov. 3, 2010

Related U.S. Application Data
(63) Continuation of application No. PCT/EP2009/054803, filed on Apr. 22, 2009.

(30) Foreign Application Priority Data
May 6, 2008 (DE) 10 2008 001574.1

(51) Int. Cl. B08B 1/00

(52) U.S. Cl. 15/256.51

(57) ABSTRACT

A scraper for scraping and/or cleaning, especially for scraping and/or cleaning of units for the production and/or treatment of a fibrous material web, and preferably for scraping and/or cleaning of drying cylinders, including a composite material which includes a resin matrix material with fibers embedded therein. Copper and/or at least one copper alloy are mixed into the resin matrix material. The resin matrix material may be substituted at least partially by silicone modified epoxy resin.

### CROSS REFERENCE TO RELATED APPLICATIONS

This is a continuation of PCT application No. PCT/EP2009/054803, entitled “SCRAPER”, filed Apr. 22, 2009, which is incorporated herein by reference.

### BACKGROUND OF THE INVENTION

1. Field of the Invention

The present invention relates to a scraper for scraping and/or cleaning, especially for scraping and/or cleaning of units in the production and/or treatment of a fibrous material web and preferably for scraping and/or cleaning of drying cylinders.

2. Description of the Related Art

Composite fiber scrapers consisting of glass and/or carbon composite materials are primarily used for scraping and/or cleaning of drying cylinders. The main focus is hereby directed to the useful service life and the cleaning efficiency of the scraper. However, a relatively high coefficient of friction is characteristic for this material combination. Such a relatively high coefficient of friction produces as a consequence a high frictional power which is required for the scraper. The drives for the respective units to which the scraper is allocated must also be sufficiently sized. Electrical consumption of these drives is also relatively high.

What is needed in the art is an improved scraper which offers a reduced coefficient of friction.

### SUMMARY OF THE INVENTION

The present invention provides a scraper that contains a matrix material, for example epoxy resin, into which copper and/or at least one copper alloy are mixed, and/or which is substituted at least partially by silicone modified epoxy. The coefficient of friction of the scraper is reduced on the basis of these characteristics. Through this reduction in the coefficient of friction the required frictional power for the scraper in the respective unit, for example in the dryer group, can be reduced, thereby being able to reduce the sizing and the electrical consumption of the drives for the respective unit.

The copper, or the at least one copper alloy respectively, is, for example, added into the resin matrix material in the form of powder or flakes. Further, at least one fibrous material, for example in the form of glass and/or carbon fibers, may be added into the matrix material. The matrix material is, for example, epoxy resin which meets the desired requirements in regard to elasticity and durability for applications of this type.

Scrapers according to the present invention having a reduced coefficient of friction can hereby be produced. Due to the reduction in the coefficient of friction the required frictional power for the unit in which the scraper is to be installed—for example the dryer group—can be reduced, thereby reducing the sizing and the electrical consumption of the drives for the unit.

The reduction in the coefficient of friction is achieved, for example, by addition of copper and/or at least one copper alloy in the form of powders or flakes into the resin matrix. Suitable fibrous materials are, for example, glass and/or carbon fibers.

An additional possibility to reduce the coefficient of friction exists in the substitution of parts of the epoxy resin matrix through silicone modified epoxy resin.

What is claimed is:

1. A scraper for at least one of scraping and cleaning associated with at least one of scraping units and cleaning units for at least one of the production and treatment of a fibrous material web, said scraper comprising:
a composite material including a plurality of fibers embedded in at least one of a resin matrix material and a silicone modified epoxy resin, at least one of copper and at least one copper alloy mixed into said resin matrix material.

2. The scraper according to claim 1, wherein said scraper is for at least one of scraping and cleaning a plurality of drying cylinders.

3. The scraper according to claim 1, wherein said at least one of copper and said at least one copper alloy is in the form of one of a powder or a plurality of flakes added into said resin matrix material.

4. The scraper according to claim 1, wherein said plurality of fibers are in the form of at least one of glass and carbon fibers.

5. The scraper according to claim 1, wherein said resin matrix material includes an epoxy resin.
